(19) United States
(12) Patent Application Publication
(10) Pub. No.: US 2010/0281433 A1
(43) Pub. Date: Nov. 4, 2010

(54) Computer Method and Apparatus Specifying Avatar Entrance and Exit

(75) Inventors: Paul B. Moody, Hyde Park, VT (US); Boas Betzler, Magstadt (DE); Rick A. Hamilton, II, Charlottesville, VA (US); Neil A. Katz, Parkland, FL (US); Brian M. O'Connell, RTP, NC (US)

Correspondence Address: HAMILTON, BROOK, SMITH & REYNOLDS, 530 VIRGINIA ROAD, PO BOX 9133, CONCORD, MA, 01742-9133, US

(73) Assignee: INTERNATIONAL BUSINESS MACHINES CORPORATION, Armonk, NY (US)

(21) Appl. No.: 12/431,911

(22) Filed: Apr. 29, 2009

(51) Int. Cl. G06F 3/048

(52) U.S. Cl. 715/850; 715/848

(57) ABSTRACT

Computer method and apparatus controls avatar relative to a subject virtual environment, in particular entrance to and/or exit from the subject environment. An entrance/exit specification engine provides a plurality of characteristics of the subject environment and/or of an avatar representing a corresponding user in the subject environment. A script generator responsive to the entrance/exit specification engine generates scripts as a function of the plurality of characteristics. The generated scripts form a script collection executable with the avatar. Execution of the generated scripts on a processor of the corresponding user controls avatar entrance to and/or exit from the subject environment.

### BACKGROUND

A Virtual Universe (VU) is a computer-based simulated environment intended for its residents to traverse, inhabit, and interact with through the use of avatars. Many VUs are represented using 3-D graphics and landscapes, and are populated by many thousands of users, known as “residents.” Other terms for VUs include metaverses, virtual world and “3D Internet.” The terms “virtual world” and “virtual universe” are used interchangeably herein.

Often, the VU resembles the real world such as in terms of physics, houses, and landscapes. Example VUs include: Second Life, Entropia Universe, The Sims Online, There, Red Light Center—as well as massively multiplayer online games such as EverQuest, Ultima Online, Lineage or World of Warcraft.

Various VU concepts are generally defined as follows.

An “avatar” is a graphical representation of a user and is typically selected by the user. Users are able to see each others' avatars in the VU. Avatars often take the form of cartoon-like human figures.

An “agent” is the user's account, upon which the user can build an avatar, and which is tied to the inventory of assets the user owns.

A “region” is a virtual area of land within the VU, typically residing on a single server.

Technically speaking, assets, avatars, the environment, and anything visual comprise respective UUIDs (universally unique identifiers—standard in the art) tied to (i) geometric data (distributed to users as textual coordinates), (ii) textures (distributed to users as graphics files such as JPEG2000 files), and (iii) effects data (rendered by the user's client according to the user's preferences and user's device capabilities).

Lastly, a “teleport offer” is an offer to instantaneously travel directly to a specific location in the VU or virtual world.

Objects in a virtual universe are composed of one or more primitive objects such as cones, triangles and polygons. The more detailed an object is (i.e. the more primitive objects it is composed of), the longer the object will take to render and download. It is common for virtual world parcels to incorporate many objects in their design.

Various problems exist in virtual universes. For example, an avatar entering into a region of a virtual universe may be distracting to those in-world. Also, the entrance by an avatar may be unnoticed by those in-world because they are looking in the wrong place. In turn, this may leave the user of the entering avatar disoriented and sometimes in a socially awkward position, stance, or posture which for those unfamiliar with controlling avatars in a virtual world may be uncomfortable. Methods are needed to overcome these drawbacks in the present art.

### BRIEF SUMMARY

In virtual universe events, avatars are displayed when users log on to the system. Generally, avatar appearances are virtual world embodiment dependant. For example, avatars may just ‘pop’ into existence, or ‘drop from the sky’ or any other number of ways of showing the arrival of a new avatar into the virtual environment. The present invention controls how avatars appear within the specific areas of the virtual environment they are entering and may be set to change depending on a number of factors including a time based scheduled event, role of the respective user, size of event, etc. Furthermore, the present invention controls the entrance path, avatar appearance/sounds, and avatar behavior. Different entrances may be specified for different modes of entry, time of entry, and so on.

The present invention contains numerous advantages over current art. The advantages include, but are not limited to:

(1) Regions may specify entrance mechanics for avatars of users entering the region.

(2) Entrances may vary based on several characteristics such as time, role, number of users in region, etc.

And

(3) Users may pay for specific entrance mechanics for regions, generating additional revenue for that region.

Preferred embodiments include a computer method and apparatus controlling avatar entrance and/or exit to a graphically simulated 3D environment. The subject environment may be a virtual world, a virtual universe, a gaming virtual environment and the like. The method includes:

given an avatar representing a user in a subject graphically simulated 3D environment, generating one or more scripts as a function of plural characteristics including characteristics of the subject environment, said generating resulting in a script collection; and

transferring the script collection to a processor of the user in a manner enabling execution of the generated scripts on the user's processor and resulting in controlled avatar entrance and/or exit to the subject environment.

The step of generating may generate respective scripts for each entrance activity of the avatar.

The plural characteristics include characteristics of the avatar such as entrance method used by the avatar, movement path of the avatar from entry point to destination, and/or post destination arrival activities of the avatar. Further the characteristics of the subject environment may include any one or combination of events, event time lines, and event presenter relative to timing of entrance/exit by the avatar.

In one embodiment, one of the generated scripts dynamically generates destination of the avatar in the subject environment, in a manner controlling number of different avatars in an area at a time. To that end, in some embodiments, the one generated script places avatars in groups in the subject environment.

In one embodiment, the script collection includes generated scripts configured to control appearance characteristics of the avatar, sound of the avatar, behavior of the avatar or any combination thereof of the avatar in the subject environment.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of an embodiment of the present invention.

FIG. 2 is a block diagram of the components of the embodiment of FIG. 1.

FIG. 3 is a flow diagram of data and control of the FIG. 1 embodiment of the present invention.

FIG. 4 is a schematic illustration of a computer network environment in which embodiments of the present invention operate.

FIG. 5 is a block diagram of a computer node in the network of FIG. 4.

### DETAILED DESCRIPTION

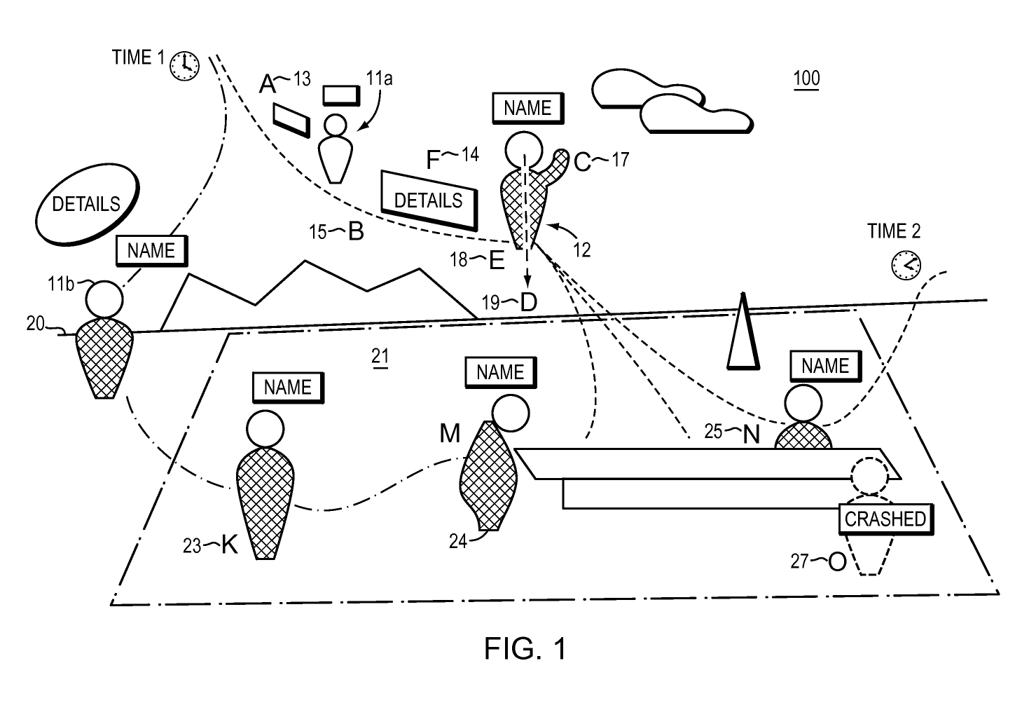

By way of overview, FIG. 1 illustrates embodiments of the present invention. A virtual world or similar computer network system 100 supporting a graphically simulated 3D environment 20 provides respective avatars 11, 12 representing users interacting in the environment. General rendering of the virtual world 20 (including space 21) and initialization and general activity of avatars 11, 12 is by common techniques. The present invention improves avatar entrance into and exit from the subject virtual world or certain regions thereof as follows.

With reference to FIG. 1, at TIME1, users with respective avatars 11a, 11b (generally 11) are brought into the virtual space 21 under script control. The invention scripts control entry point A 13 motion path B 15 and dynamics C 17 of avatar 12, their viewpoint D 19, presentation E 18 to them, and adornment F 14.

At TIME2 (at right-hand side of FIG. 1), the entry script elements may differ from the ones used at TIME1.

Users 11a, 11b receive different script element sets depending on rank, invitee status, etc.

Users/respective avatars 11 are landed at the end of their motion path as illustrated at K 23. The landed avatars may have scripts to control their post arrival (in virtual space 21) actions such as bowing to Asian avatar 24 as shown at M or saluting to higher ranking avatar, etc., before being seated N 25 by a seating script. The seating script chooses a seat for the subject avatar based on a number of patterns or by random, by role, by affiliation or company, by age, etc.

Exiting the region 21 is also control by scripts, and can include all the script elements that arrivals use. In addition, exit scripts include special loss of connection scripts 27 that help others in-world know when someone has crashed versus left the region as illustrated at O.

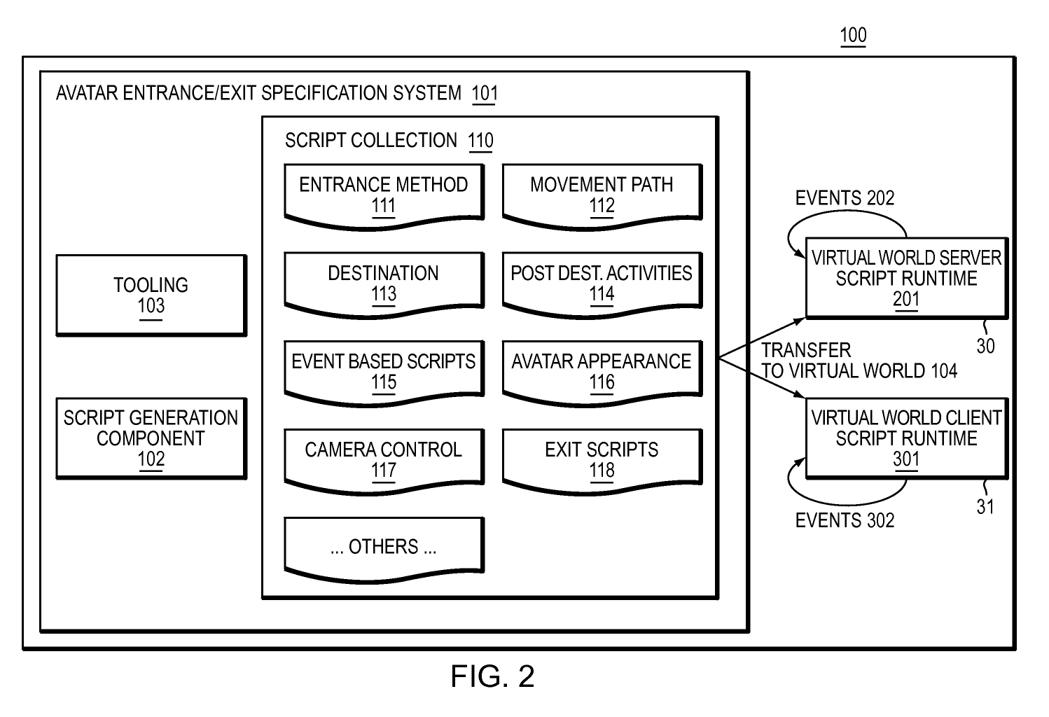

Turning now to FIG. 2, components and methods of embodiments 100 of the invention are described next. An embodiment (virtual world system) 100 is formed of an avatar entrance/exit specification engine (or system) 101, a script generator 102, a script collection 110 and tools (graphical user interface tooling) 103.

Avatar Entrance/Exit Specification System 101

By the avatar entrance/exit specification system 101, entrance and exit scripts 111 through 118 (collectively 110) are dynamically generated, transferred to virtual world 104 clients 31, and executed at client script runtime 301. In turn, various corresponding virtual world 104 activities and events 302 result. Multiple components and methods including script generation component 102 are employed to dynamically generate the pertinent scripts as detailed below.

Script Generation Component 102

The script generation component 102 creates a new script 111-118 for each avatar entrance activity. The script is generated based on a series of characteristics and predetermined actions for each characteristic. After generation, these scripts 110 (collectively) are transferred to the virtual universe 104 client and executed by the client 31 (client runtime 301). The following is a list of example characteristics and some predetermined actions for each characteristic.

Entrance Method Script 111

The generated script for each avatar may be modified based on the entrance method used by the avatar. For example, teleporting to a location may result in a different generated script 111 than flying or walking into a region 21 or event 302.

Movement Path Script 112

This script 112 specifies a movement path 15 for the subject user/avatar 11a. Once the subject avatar 11a enters the region (e.g., entry point A 13) and before he reaches his destination 23, the script 112 dynamically generates the movement path 15 based on the location and number of other avatars 12 in the region 21/event 302. If the user/avatar 11a is entering an event 302, the movement path 15 may be selected based on the event time-line as described in the event based scripts 115 specification below. The movement path script 112 may generate a movement path 15 that allows substantially all users within the region to have an opportunity to see a newly arriving guest or that allows the avatar's entrance to be difficult to notice so as to not distract other users. The generated movement path 15 avoids blocking the view of other users.

Destination Script 113

The destination 23 is dynamically generated. The invention destination script 113 may generate a destination 23 to prevent too many avatars 11, 12 from being in one region (location or area). In other embodiments, the destination script 113 may place avatars in groups based on predetermined relationships (friend lists, same company), language preferences, or inventory commonality, for example.

Post Destination Activities Script 114

Prior to returning control to the user, the invention system may execute post destination arrival activities. This may be accomplished by one or more post destination activity scripts 114. The post destination arrival/post-landed activities may include waving to those near the subject avatar, sitting down in a chair, or if in a meeting with Japanese colleagues the script 114 might have the avatar bow to each Asian participant, and then seat the avatar in a chair based on a seating arrangement encoded in the script 114.

Event Based Scripts 115

The present invention may be used to create entrances to virtual world events 302 such as presentations, “meet-ups” or other such activities. The generated entrance script 110 may vary based on the event time-line. The time-line may be absolute time relative to event start, status of the event (current presenter), current agenda item (meet and greet, keynote, panel discussions, breakout, etc) and in particular for business meetings who is presenting and the timing of the entrance or exit. For example, if an avatar enters during a meet and greet, the event based script 115 may specify a flashier entrance to draw attention to a new person (his respective avatar) entering, whereas if an avatar enters during the keynote he may be brought in a manner as to not distract other users viewing the keynote.

Avatar Appearance Script 116

The generated script 110 may specify avatar appearance characteristics. For example, the avatar could be ghosted, larger than life, with large signage as to their name (see FIG. 1 for name signage illustrations), etc. This is accomplished by pertinent appearance scripts 116.

Avatar Camera Control Script 117.

In addition to specifying entrance of the user/respective avatar as viewed by those already in the region/event 302 the script (through camera control scripts 117) also controls in-world camera view while the avatar is being moved along the path. Such a system may provide an “establishing shot” as the subject avatar enters the region or event. Script 117 controls may include a viewing vector, zoom, pan, orbit, and the like similar to those for routine avatar movements but implemented here during automated arrival (or departure). Camera feature techniques and manipulations common in the art are utilized.

Exit Scripts 118

Exit scripts 118 may be generated when a user/avatar 11 leaves a venue. Scripts 118 may differ based on the user's (his avatar's) exit method. For example, teleporting away may result in a different exit script 118 than a network error. Exit scripts 118 may be generated based on all characteristics defined above. Since the virtual universe 104 client may no longer be connected to the region 23, exit scripts 118 are executed by the server for the region (e.g., server script runtime 201 supporting events 202 in FIG. 2).

Tools 103

To enable the present invention 2D and 3D in-world tools for designing the scripts 110, embodiment systems 100 should provide the recording of path, use of inventory during parts of the entrance for labeling, gesture libraries, etc. The tooling component 103 then generates tools based on known scripting techniques and manipulations methods.

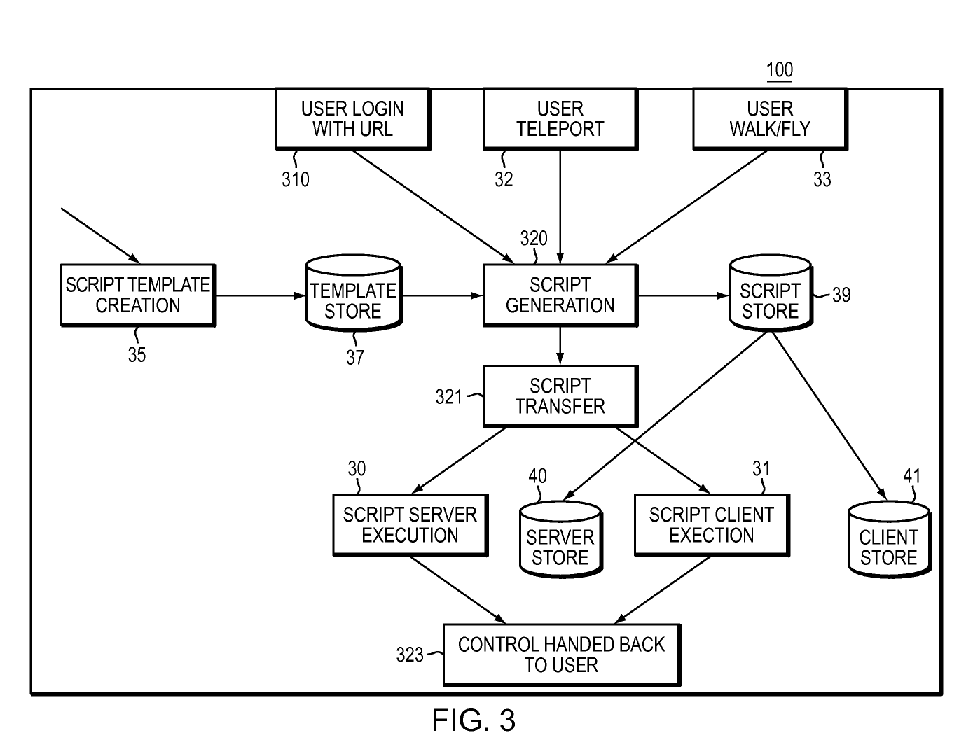

Turning now to FIG. 3, illustrated are the method steps implementing the foregoing components 101, 102 and 103 and script collection 110 of embodiments 100 of the present invention.

A user requests to join an in-world event 302 by (but not limited to) logging in 310 using a URL for the event space, teleporting 32 his avatar to the event space, or flying/walking 33 his avatar into the event space. In response, invention system 100 at step 320 generates a collection of scripts 110 and stores them in script store 39.

In particular, the invention system 100 at step 320 generates an entrance script 111 for the client 31. In generating the entrance script 111, step 320 optionally bases entrance on some number of characteristics such as time-line of the event 302 (segment or absolute time relative to event start, etc.), status of the event 302 (e.g., current presenter), method of entrance (direct arrival in-world from login, teleport from other in-world location, walk/fly-in, etc.) Event based scripts 115 result. In one embodiment, Step 320 may utilize script templates created at 35 and stored in a template store 37.

The invention system 100 establishes a movement path 15 by teleporting the subject avatar to a particular location, and then moving the avatar along a predetermined path to an arrival destination 23 in the event venue (e.g., virtual space 21). The result is a movement path script 112 and destination script 113.

Next, the invention system 100/step 320 generates scripts 117 to control in-world camera view while the avatar is being moved along the path (to give the user/avatar an “establishing shot” view of the venue 21). Script 117 controls include viewing vector, zoom, pan, orbit, etc. as described above.

Step 320 creates scripts 116 to control the avatar appearance while being moved along the path 15.

Step 320 builds controls (scripts 114) for avatar behaviors while they are ‘entering’ the venue 21 which might include after they have arrived at the destination 23, but before the user is expected to take control of the avatar as described and illustrated above in FIG. 1.

Step 321 transfers the above generated scripts 110 to the user's virtual world client 31 for execution. The script store 39 may be replicated or duplicated as a client store 41 and server store 40 to support client 31 script runtime execution and server 30 script runtime execution respectively.

In a similar manner, step 320 may generate exit scripts 118 as pertinent. Step 321 transfers exit scripts 118 to the user's virtual world client 31 or server 30 for execution accordingly. Exit may be modified based on exit type, such as system crashes, lost network connection, or teleportation as discussed above in FIG. 2. After execution of scripts 110, control is headed back (returned) to the user as shown at step 323.

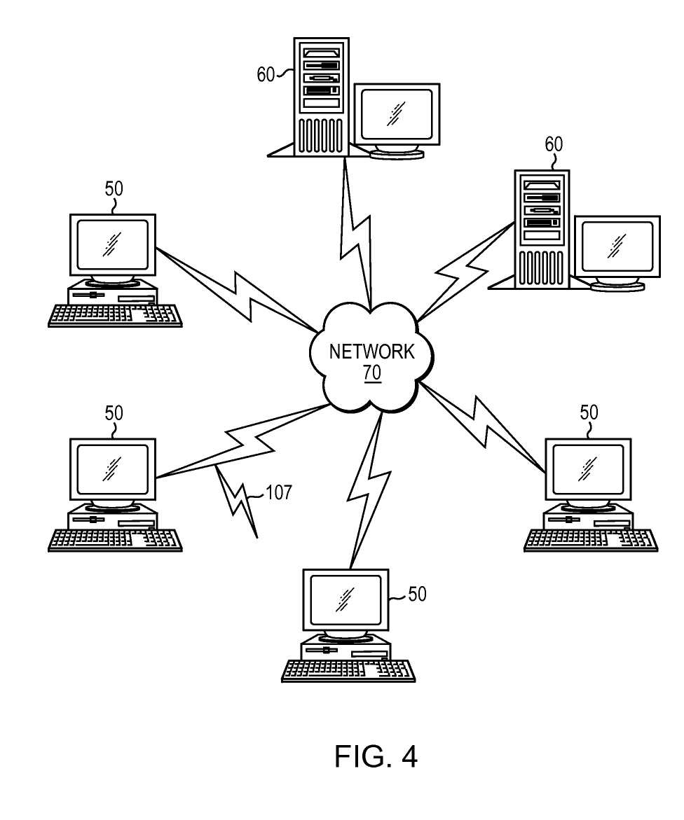

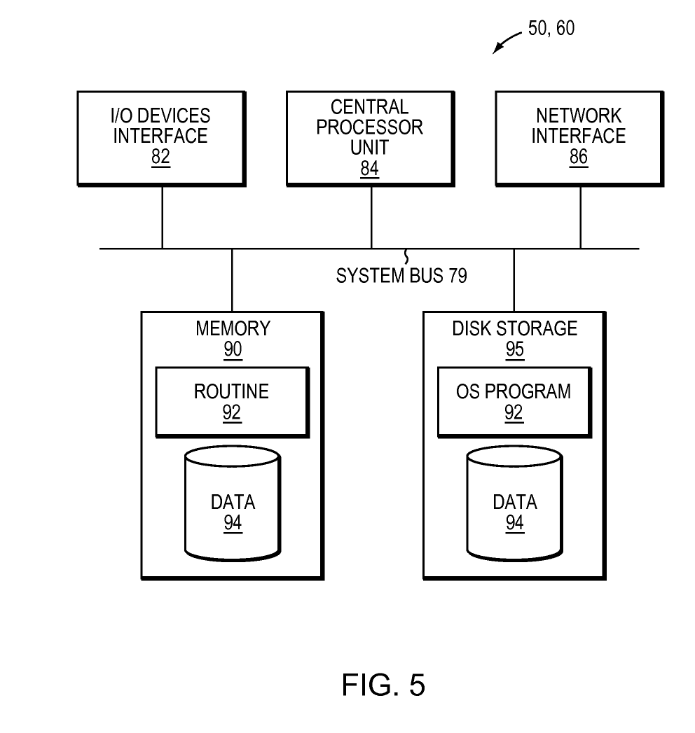

With reference now to FIGS. 4 and 5, FIG. 4 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 5 is a diagram of the internal structure of a computer (e.g., client processor/device 50 or server computers 60) in the computer system of FIG. 4. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 4). Memory 90 provides volatile storage for computer software instructions 92 and data 94 used to implement an embodiment of the present invention (e.g., entrance/exit specification engine 101, script generator 102 and collection of scripts 110 detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

For example, a client-server architecture is described and discussed above for purposes of illustration and not limitation of embodiments of the present invention. It is understood that other computer architectures and configurations are suitable for implementing embodiments of the present invention.

Given the above description of various embodiments, included in the present invention is the temporary and temporally specific region control of the avatar line of sight (i.e., during an automated arrival or departure process). Further the present invention enables the region designer to develop ways for specific users, classes of users, and/or users at a specific time to enter the region and arrive at region specified destinations based on user identity for example. The present invention provides region control of coordinated avatar movement as part of an arrival or departure process based on a number of criteria (versus an individual unilateral control of coordinated avatar movement issued manually).

What is claimed is:

1. A computer method controlling avatar entrance to a graphically simulated 3D environment, the method comprising:
given an avatar representing a user in a subject graphically simulated 3D environment, generating one or more scripts as a function of plural characteristics including characteristics of the subject environment, said generating resulting in a script collection; and
transferring the script collection to a processor of the user in a manner enabling execution of the generated scripts on the user's processor and resulting in controlled avatar entrance to the subject environment.

2. A method as claimed in claim 1 wherein the step of generating generates respective scripts for each entrance activity of the avatar.

3. A method as claimed in claim 1 wherein the plural characteristics include characteristics of the avatar.

4. A method as claimed in claim 3 wherein the characteristics include entrance method used by the avatar.

5. A method as claimed in claim 3 wherein the characteristics include movement path of the avatar from entry point to destination.

6. A method as claimed in claim 3 wherein the characteristics include post destination arrival activities of the avatar.

7. A method as claimed in claim 1 wherein one of the generated scripts dynamically generates destination of the avatar in the subject environment, in a manner controlling number of different avatars in an area at a time.

8. A method as claimed in claim 7 wherein the one generated script places avatars in groups in the subject environment.

9. A method as claimed in claim 1 wherein the characteristics of the subject environment include any one or combination of events, event time lines, and event presenter relative to timing of entrance by the avatar.

10. A method as claimed in claim 1 further comprising controlling any combination of:
appearance characteristics of the avatar, sound of the avatar and behavior of the avatar in the subject environment using the generated scripts.

11. A method as claimed in claim 1 wherein the generated scripts further control avatar exit from the subject environment.

12. A method as claimed in claim 1 wherein the subject environment is any of a virtual world, virtual universe, and gaming virtual environment.

13. Computer apparatus controlling avatar entrance, comprising:
an entrance specification engine providing a plurality of characteristics of at least an avatar representing a corresponding user in a subject graphically simulated 3D environment; and
a script generator responsive to the entrance specification engine and generating one or more scripts as a function of the plurality of characteristics, the generated scripts forming a script collection executable with the avatar, wherein execution of the generated scripts on a processor of the corresponding user controls avatar entrance to the subject environment.

14. Computer apparatus as claimed in claim 13 wherein the script generator generates respective scripts for each entrance activity of the avatar.

15. Computer apparatus as claimed in claim 13 wherein the entrance specification engine provides a plurality of characteristics of the subject environment including any one or combination of events, event time lines, and event presenter relative to timing of entrance by the avatar.

16. Computer apparatus as claimed in claim 13 wherein the characteristics of the avatar include any of: entrance method used by the avatar, movement path of the avatar from entry point to destination, and post destination arrival activities of the avatar.

17. Computer apparatus as claimed in claim 13 wherein one of the generated scripts dynamically generates destination of the avatar in the subject environment, in a manner controlling number of different avatars in an area at a time.

18. Computer apparatus as claimed in claim 17 wherein the one generated script places avatars in groups in the subject environment.

19. Computer apparatus as claimed in claim 13 wherein the script collection includes generated scripts configured to further control any combination of:
appearance characteristics of the avatar, sound of the avatar and behavior of the avatar in the subject environment.

20. Computer apparatus as claimed in claim 13 wherein the generated scripts further control avatar exit from the subject environment.

21. Computer apparatus as claimed in claim 13 wherein the subject environment is any of a virtual world, virtual universe, and gaming virtual environment.

22. A computer program product for controlling an avatar relative to a virtual environment, the computer program product comprising:
a computer usable medium having computer usable program code embodied therewith, the computer usable program code comprising:
computer usable program code configured to generate a script collection as a function of plural characteristics including characteristics of any of the virtual environment and an avatar representing a user in the virtual environment; and
computer usable program code configured to transfer the script collection to a processor of the user in a manner enabling execution of scripts from the script collection, on the user's processor and resulting in at least one of controlled avatar entrance and controlled avatar exit relative to the virtual environment.
